(19) United States
(12) Patent Application Publication
(10) Pub. No.: US 2025/0093170 A1
(43) Pub. Date: Mar. 20, 2025

(54) DEVICE AND METHOD FOR PROVIDING INFORMATION BASED ON SPEECH RECOGNITION

(71) Applicants: Hyundai Motor Company, Seoul (KR); Kia Corporation, Seoul (KR)

(72) Inventor: Chang Woo Chun, Suwon (KR)

(21) Appl. No.: 18/671,500

(22) Filed: May 22, 2024

(30) Foreign Application Priority Data
Sep. 19, 2023 (KR) 10-2023-0124835

(51) Int. Cl. G01C 21/36; G10L 15/08

(52) U.S. Cl. CPC G01C 21/3608; G01C 21/3644; G10L 15/08

(57) ABSTRACT

A device and a method are configured to provide information based on speech recognition. The device includes a memory storing computer-executable instructions and a processor. The processor is configured to execute the computer-executable instructions to classify an utterance intent of a speech utterance of a vehicle occupant, extract at least one keyword corresponding to a slot of the utterance intent from the speech utterance, obtain location information corresponding to the at least one keyword by applying a first deep learning model to the at least one keyword when the utterance intent is route setting, and provide a navigation route from a current location of the vehicle occupant to the location information.

### CROSS REFERENCE TO RELATED APPLICATION

This application claims under 35 U.S.C. § 119(a) the benefit of Korean Patent Application Number 10-2023-0124835, filed on Sep. 19, 2023 in the Korean Intellectual Property Office, the entire contents of which are incorporated herein by reference.

### BACKGROUND

### (a) Technical Field

The present disclosure relates to a device and method for providing information based on speech recognition.

### (b) Description of the Related Art

As artificial intelligence techniques have recently developed, their applications are also broadening. In particular, conversation systems that enable conversations with users using natural language, such as chatbots or virtual assistants, are being used in various fields, and the technology is gradually developing. In order for a conversation system to conduct a conversation with a user, it is necessary to understand the user's utterance, that is, an input message, from the perspective of the conversation system. In order to achieve this natural language understanding (NLU), the conversation system needs to derive the current context and the user's intent expected in that context from the conversation between the conversation system and the user, and analyze the input message based on the derived context and/or intent.

The scope of application of these speech recognition services is expanding from home to various fields such as vehicles. In other words, a speech recognition assistant service and a telematics service are linked, and voice commands generated by a user's voice are transmitted to a car to control the car. Through this, a user can lock/unlock a vehicle's doors, or turn on the air conditioner in advance to control the temperature inside the vehicle.

In order to provide such a speech recognition service, an information providing device for providing information to a vehicle occupant is required to recognize various utterances of the occupant and provide necessary information based on the recognized utterances.

However, a conventional speech recognition-based information providing device linked to the vehicle has a problem in that it cannot flexibly interpret the occupant's voice.

As an example, when the vehicle occupant utters a new name that is not included in a point of interest (POI) database or utters an abbreviation of a POI name included in the POI DB, the information providing device may not be able to retrieve information about the POI name. For example, when the POI DB does not store a POI name for a road link, the information providing device cannot provide the route to the road link even when the occupant speaks the road link name as the destination.

As another example, when the vehicle occupant asks a question about a specific location or navigation route, the information providing device may not be able to provide an appropriate answer.

### SUMMARY

According to at least one embodiment, the present disclosure provides a device for providing information based on speech recognition in a vehicle. The device comprises at least one memory storing computer-executable instructions; and at least one processor. The at least one processor is configured to execute the computer-executable instructions to classify an utterance intent of a speech utterance of an occupant of the vehicle, extract at least one keyword corresponding to a slot of the utterance intent from the speech utterance, obtain location information corresponding to the at least one keyword by applying a first deep learning model to the at least one keyword when the utterance intent is route setting, and provide the occupant with a navigation route from a current location of the occupant to the location information.

A vehicle may include the device for providing information based on speech recognition.

According to another embodiment of the present disclosure provides a computer implemented method for providing speech recognition-based information. The method comprises classifying an utterance intent of a speech utterance of an occupant of a vehicle; extracting at least one keyword corresponding to a slot of the utterance intent from the speech utterance; obtaining location information corresponding to the at least one keyword by applying a first deep learning model to the at least one keyword when the utterance intent is route setting; and providing the occupant with a navigation route from a current location of the occupant to the location information.

### BRIEF DESCRIPTION OF THE DRAWINGS

FIG. 1 is a block diagram of an information providing device according to one embodiment of the present disclosure.

FIG. 2 is a block diagram of a speech recognition module according to one embodiment of the present disclosure.

FIGS. 3A and 3B are diagrams for explaining training of deep learning models according to one embodiment of the present disclosure.

FIG. 4 is a flowchart of a route providing method according to one embodiment of the present disclosure.

FIG. 5 is a diagram illustrating an example of the route providing method according to one embodiment of the present disclosure.

FIG. 6 is a flowchart of a method for providing a POI name according to one embodiment of the present disclosure.

FIGS. 7A to 7D are diagrams illustrating examples of the POI name providing method according to one embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

An object of an exemplary embodiment of the present disclosure is to provide a device and method for retrieving a location for a name or abbreviation not stored in a POI DB from an utterance of an occupant of a vehicle and providing a navigation route based on the location.

An object of another exemplary embodiment of the present disclosure is to provide a device and method for providing response information to various utterances of an occupant of a vehicle using a deep learning model capable of flexible conversion between text information and location information.

Embodiments of the present disclosure are described below in detail using various drawings. It should be noted that when reference numerals are assigned to components in each drawing, the same components have the same reference numerals as much as possible, even if they are displayed on different drawings. Furthermore, in the description of the present disclosure, where it has been determined that a specific description of a related known configuration or function may obscure the gist of the disclosure, a detailed description thereof has been omitted.

In describing the components of the embodiments according to the present disclosure, symbols such as first, second, i), ii), a), and b) may be used. These symbols are only used to distinguish components from other components. The identity or sequence or order of the components is not limited by the symbols. In the specification, when a part “includes” or is “equipped with” an element, this means that the part may further include other elements, not excluding other elements unless explicitly stated to the contrary. Further, when an element in the written description and claims is described as being “for” performing or carry out a stated function, step, set of instructions, or the like, the element may also be considered as being “configured to” do so.

Each component of a device or method according to the present disclosure may be implemented in hardware or software, or in a combination of hardware and software. In addition, the functions of each component may be implemented in software. A microprocessor or processor may execute functions of the software corresponding to each component.

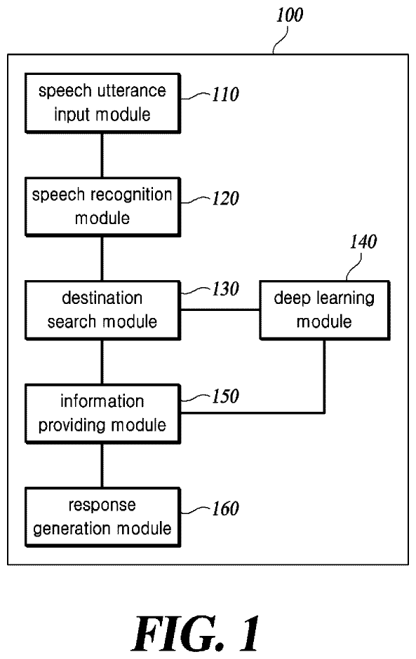

FIG. 1 is a block diagram of an information providing device according to one embodiment of the present disclosure.

Referring to FIG. 1, an information providing device 100 classifies intents and slots according to various utterances of an occupant of a vehicle, extracts keywords corresponding to slots within the utterances, and provides location information or name information corresponding to the keywords to the occupant.

In particular, the information providing device 100 may process various utterances of the occupant using deep learning models capable of converting between location information and text information.

For this purpose, the information providing device 100 includes a speech utterance input module 110, a speech recognition module 120, a destination search module 130, deep learning models 140, an information providing module 150, and a response generation module 160.

The information providing device 100 may include at least one processor and a memory including at least one instruction, and may perform the functions of the speech utterance input module 110, the speech recognition module 120, the destination search module 130, the deep learning models 140, the information providing module 150, and the response generation module 160 through execution of the instruction by the processor. The information providing device 100 may further include a communication unit for communication with an external device, and a positioning unit for estimating the location of the vehicle or occupant.

The components of the information providing device 100 may be implemented in either a vehicle or a server. Alternatively, some of the components of the information providing device 100 may be implemented in the vehicle and others may be implemented in the server.

The speech utterance input module 110 acquires the occupant's utterance received by a microphone in the vehicle.

In this case, the occupant's utterance is a voice signal of audio data, and the speech utterance input module 110 receives the voice signal corresponding to the occupant's utterance.

When the information providing device 100 is included in a server computer outside the vehicle, the speech utterance input module 110 may receive the occupant's utterance from the vehicle through wireless communication, obtain appropriate information according to the utterance, and transmit the information to the vehicle so that the information is output to the occupant. When the information providing device 100 is included in the vehicle, the speech utterance input module 110 may receive the occupant's utterance from the microphone in the vehicle, obtain appropriate information according to the utterance, and provide the information to the occupant through a user interface of the vehicle.

The speech utterance input module 110 may preprocess the voice signal corresponding to the occupant's utterance. For example, the speech utterance input module 110 may perform preprocessing to reduce noise in the voice signal.

The speech recognition module 120 may recognize and understand the occupant's utterance by classifying the utterance intent and slot for the occupant's utterance.

Specifically, the speech recognition module 120 may convert the occupant's utterance into a text sentence and extract the utterance intent and at least one keyword corresponding to the slot of the utterance intent based on the text sentence.

In this case, the utterance intent may be classified as any one of route setting, POI guidance, route description, accident information guidance, or congested section check. In addition, the utterance intent may be classified into various classes such as destination search, destination change, waypoint addition, waypoint change, or making a phone call.

The slot refers to a semantic object required to provide information according to the utterance intent. The slot may be predefined for each utterance intent. As an example, a slot for a routing intent may be a destination or a waypoint. The keyword corresponding to the slot may be home or company.

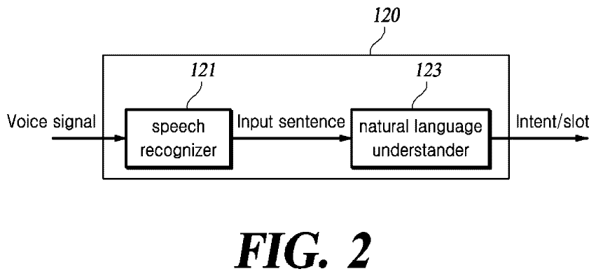

The specific operation of the speech recognition module 120 is explained in FIG. 2.

The destination search module 130 retrieves location information for at least one keyword extracted by the speech recognition module 120. In particular, when the utterance intent is classified as route setting, location information for the keyword may be retrieved.

To search for location information, the destination search module 130 includes a POI DB in which POI names and location information corresponding to each POI name are stored. As an example, the POI name “home” and the address or latitude/longitude of “home” may be stored in the POI DB.

The destination search module 130 retrieves the keyword extracted by the speech recognition module 120 in the POI DB. If the keyword is the same as the POI name stored in the POI DB, the destination search module 130 can obtain location information according to the keyword from the POI DB.

On the other hand, if the POI name identical to the keyword is not stored in the POI DB, the destination search module 130 can search for location information according to the keyword using deep learning models 140. The destination search module 130 may input the keyword into a first deep learning model among the deep learning models 140 and obtain location information corresponding to the keyword from the first deep learning model.

In this case, the deep learning models 140 are neural network models capable of conversion between text information and location information. The deep learning models 140 may include a first deep learning model that converts text information into location information, and a second deep learning model that converts location information into text information.

The first deep learning model may receive a keyword extracted from an utterance as input and output location information corresponding to the keyword. The first deep learning model may output similar location information in response to receiving similar keywords as input. In particular, the first deep learning model may train text other than POI names in the POI DB.

The second deep learning model may receive location information as input and output a keyword corresponding to the location information. The second deep learning model may output at least one POI name corresponding to the location information in response to receiving one location information.

The first deep learning model and the second deep learning model may each be composed of a deep neural network and may have various neural network structures. For example, the deep learning models may have various neural network structures capable of implementing natural language processing techniques, such as a convolutional neural network (CNN), a recurrent neural network (RNN), or a combined structure of RNN and CNN.

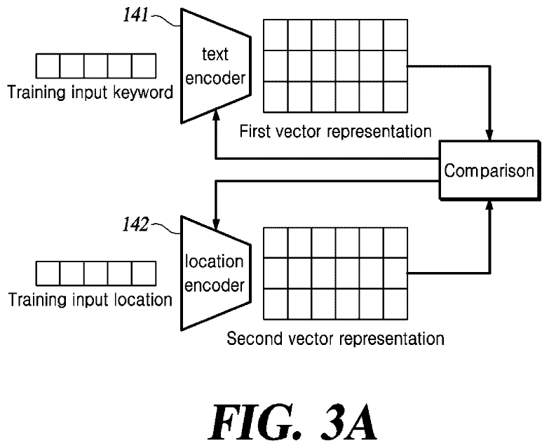

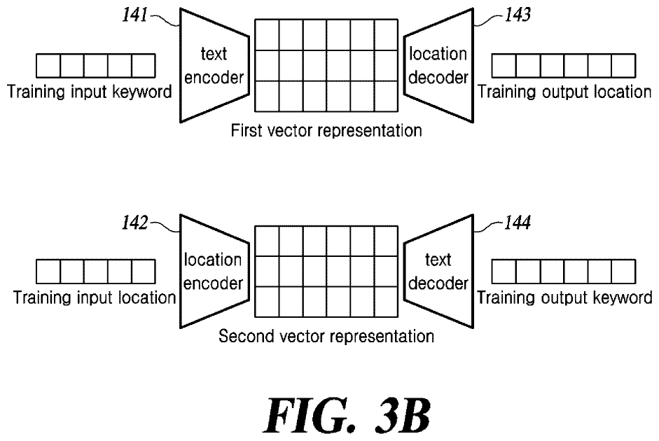

The training of the first deep learning model and the second deep learning model is described in FIGS. 3A and 3B.

In other words, even if the keyword is not a name in the POI DB or is an abbreviation of a POI name, the destination search module 130 can obtain location information for the keyword using the first deep learning model.

The information providing module 150 provides appropriate information to the occupant based on the occupant's utterance intent, the keyword corresponding to the slot, or the location information corresponding to the keyword.

When the utterance intent is route setting, the information providing module 150 may provide a navigation route based on the location information obtained by the destination search module 130. Specifically, the information providing module 150 may store map information, generate a navigation route from the current location of the vehicle occupant based on the map information to the location information obtained by the destination search module 130, and provide the navigation route.

Furthermore, the information providing module 150 may provide various information for the occupant' various utterance intents. The information providing module 150 may identify location information according to the keyword in the occupant's utterance and provide a POI name corresponding to the location information.

Specifically, when the utterance intent is any of POI guidance, route description, accident information guidance, or congested section check, the information providing module 150 may identify location coordinates based on the keyword, and apply the second deep learning model to the location coordinates to obtain and provide the POI name.

Specifically, when the utterance intent is POI guidance, the information providing module 150 acquires first location coordinates around the target location according to the keyword, and applies the second deep learning model to the first location coordinates to obtain and provide first POI names.

When the utterance intent is a route description, the information providing module 150 acquires second location coordinates in the navigation path according to the keyword, and applies the second deep learning model to the second location coordinates to obtain and provide second POI names.

When the utterance intent is accident information guidance, the information providing module 150 identifies third location coordinates for the accident point within a spatial range according to the keyword based on accident information, and applies the second deep learning model to the third location coordinates to obtain and provide third POI names. The accident information may be pre-stored in the information providing device 100 or received in real time from outside.

When the utterance intent is congested section check, the information providing module 150 identifies fourth location coordinates for the congested section within a spatial range according to the keyword based on traffic information, and applies the second deep learning model to the fourth location coordinates to obtain and provide fourth POI names. In this case, the traffic information includes the level of road congestion, traffic volume, average speed of vehicles, signal information, lane information, etc., and may be stored in advance in the information providing device 100 or received in real time from the outside.

The response generation module 160 generates a response to be output to the occupant based on the information provided from the information providing module 150.

The response generation module 160 may generate the response in the form of an image output on a display or in the form of audio output through a speaker.

The response generation module 160 may use a generative model to generate a response that is easy for the occupant to recognize. The response generation module 160 may use the generative model to generate a complete sentence from the utterance intent, slot, keyword, and information from the information providing module 150.

FIG. 2 is a block diagram of the speech recognition module according to one embodiment of the present disclosure.

Referring to FIG. 2, the speech recognition module 120 can recognize and understand the user's voice by classifying the intent and slot of the user's voice.

To this end, the speech recognition module 120 includes a speech recognizer 121 that converts the user's speech utterance into text, and a natural language understander 123 that classifies the intent and slot included in the user's speech utterance.

The speech recognizer 121 may use at least one speech recognition engine to convert the user's utterance into an input sentence. In this case, the speech recognition engine may refer to a speech to text (STT) engine, and may convert a voice signal representing the user's utterance into text by applying a speech recognition algorithm or neural network model to the voice signal.

For example, the speech recognizer 121 may apply a feature vector extraction technique such as Cepstrum, Linear Predictive Coefficient (LPC), Mel Frequency Cepstral Coefficient (MFCC), or Filter Bank Energy to extract a feature vector from the user utterance. The speech recognizer 121 may obtain a recognition result by comparing the extracted feature vector with a trained reference pattern. For this purpose, an acoustic model that models and compares the signal characteristics of speech or a language model that models the linguistic order relationship of words or syllables corresponding to recognition vocabulary may be used.

The speech recognizer 121 is also capable of converting user utterances into text based on a model that applies machine learning or deep learning.

The natural language understander 123 uses at least one natural language understanding (NLU) engine to classify user intent and slots included in the input sentence.

The natural language understander 123 may extract information such as domains, entity names, and speech acts from input sentences using the NLU engine, and extract intent and slots based on the extraction results. In this case, the slot may be referred to as an entity representing a semantic object.

Specifically, the NLU engine may segment the input sentence into morphemes, project the morphemes into a vector space, group the projected vectors to classify the intent according to the input sentence, and extract components corresponding to the slots of the intent in the input sentence as entities.

As an example, when the input sentence is “When do I change the engine oil?”, the NLU engine segments the input sentence into “engine”, “oil”, “when”, “change”, and “do”, and converts each morpheme into vector. Then, the NLU engine classifies the intent corresponding to the vector based on the similarity between the vectors and their location in the vector space. The NLU engine may use a classification model for intent classification. In the above example, the utterance intent is consumable replacement check, and the slot corresponding to the utterance intent is the consumable name. The NLU engine extracts “engine” and “oil” as consumable names. Then, the response generation module may generate the sentence “Engine oil change interval is 15,000 km” based on the intent of the consumable replacement check, and the keywords “engine” and “oil”.

As another example, when the input sentence is “Call Gildong Hong”, the NLU engine tokenizes the input sentence into “Gildong Hong”, and “call”. The NLU engine determines from the tokens that the utterance intent of the input sentence is “make a call.” The slot of the utterance intent is “call target,” and in this case, the NLU engine may extract the keyword “Gildong Hong”.

As another example, when the input sentence is “Let's go home”, the utterance intent is [route setting], and the slot corresponding to the intent is [origin, destination]. As another example, when the input sentence is “turn on the air conditioner”, the utterance intent is [air conditioner power on], and the slot corresponding to the utterance intent is [temperature, wind volume].

FIGS. 3A and 3B are diagrams for explaining training of the deep learning models according to one embodiment of the present disclosure.

First, the first deep learning model includes a text encoder for encoding text information into a vector representation, and a location decoder for decoding location information from the vector representation. The text encoder and the location decoder may sequentially convert a plurality of keywords into location coordinates.

The second deep learning model includes a location encoder for encoding location information into a vector representation, and a text decoder for decoding keywords from the vector representation. The location encoder and the text decoder may sequentially convert a plurality of location coordinates into POI names.

As training data for the first deep learning model and the second deep learning model, a training data set including text information and location information is prepared. In this case, the text information includes POI names, and the location information includes locations corresponding to the POI names.

One POI name may correspond to one location coordinate or a plurality of location coordinates. As an example, the text information may include the name of the road link, and the location information may include the locations of points along the road link at predetermined intervals. In this case, one road link name corresponds to a plurality of location coordinates.

One location coordinate may correspond to one POI name or a plurality of POI names. As an example, the location information may include the location of a building, and the text information may include names of stores in the building. In this case, one building location corresponds to a plurality of store names.

Referring to FIG. 3A, the process of training a text encoder 141 of the first deep learning model and a location encoder 142 of the second deep learning model is shown.

The first deep learning model and the second deep learning model may be trained by an information providing device. In another embodiment, the first deep learning model and the second deep learning model may be trained by a training device.

Both the first deep learning model and the second deep learning model may be self-supervised learning.

The text encoder 141 of the first deep learning model has trained to encode a training input keyword into a first vector representation. The location encoder 142 of the second deep learning model has trained to encode a training input location into a second vector representation.

In particular, the text encoder 141 and the location encoder 142 may be trained in a cross-domain manner. The cross-domain method is a learning method in which two encoders reflect each other's domain into their own domain.

Specifically, the training device prepares a training input keyword and a training input location. In this case, the training input keyword and the training input location correspond to each other. For example, the training input keyword may be a highway name, and the training input location may be at least one location coordinate corresponding to the highway name.

The text encoder 141 encodes the training input keyword into the first vector representation, and the location encoder 142 encodes the training input location into the second vector representation.

The training device calculates the difference between the first and second vector representations and updates the parameters of the text encoder 141 and the parameters of the location encoder 142 to reduce the difference.

Through training repetition, the text encoder 141 and the location encoder 142 can encode a specific keyword and location information corresponding to the specific keyword into the same vector representation. This vector representation space is referred to as a common vectorized text-spatial representation.

Referring to FIG. 3B, a location decoder 143 is trained based on the trained text encoder 141, and a text decoder 144 is trained based on the trained location encoder 142.

Specifically, the training device inputs the first vector representation encoded from the training input keyword by the text encoder 141 to the location decoder 143, and obtains a training output location from the location decoder 143. The training device compares the training output location with the label for the training input keyword, and updates the parameters of the location decoder 143 based on the comparison result. That is, the location decoder 143 is trained to output a training output location corresponding to the training input keyword from the first vector representation.

The training device inputs the second vector representation encoded from the training input location by the location encoder 142 to the text decoder 144, and obtains a training output keyword from the text decoder 144. The training device compares the training output keyword with the label for the training input location, and updates the parameters of the text decoder 144 based on the comparison result. That is, the text decoder 144 is trained to output the training output keyword corresponding to the training input location from the second vector representation.

Meanwhile, in one embodiment, the location decoder 143 may be trained to output one location coordinate from one vector representation, and the text decoder 144 may be trained to output one keyword from one vector representation.

In another embodiment, the location decoder 143 may be trained to output a plurality of location coordinates from one vector representation, and the text decoder 144 may be trained to output a plurality of keywords from one vector representation.

Based on the above-described training process, the first deep learning model and the second deep learning model are capable of converting between text information and location information.

In another embodiment, the text encoder 141 may not be trained in conjunction with the location encoder 142, but may be trained as a unit with the location decoder 143. Similarly, the location encoder 142 may not be trained in conjunction with the text encoder 141, but may be trained as a unit with the text decoder 144.

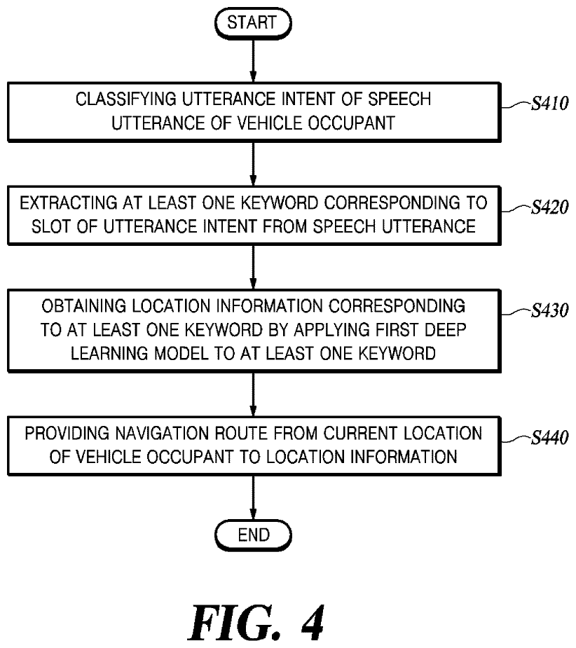

FIG. 4 is a flowchart of a route providing method according to one embodiment of the present disclosure.

Referring to FIG. 4, the information providing device classifies an utterance intent of a speech utterance of a vehicle occupant (S410).

According to one embodiment, the utterance intent may be classified as one of route setting, destination search, destination change, waypoint addition, or waypoint change.

The information providing device extracts at least one keyword corresponding to the slot of utterance intent from the speech utterance (S420).

In this case, the slot of utterance intent is a destination or waypoint, and at least one keyword has the meaning of the destination or waypoint.

In particular, the keyword may be an abbreviation of the POI name or a name not stored in the POI DB.

The information providing device obtains location information corresponding to at least one keyword by applying the first deep learning model to the at least one keyword (S430).

In this case, the first deep learning model includes a text encoder trained to encode the training input keyword into the first vector representation, and a location decoder trained to output a training output location corresponding to the training input keyword from the first vector representation.

Even if the keyword is an abbreviation of the POI name or a name not stored in the POI DB, the information providing device can obtain location information corresponding to the keyword using the first deep learning model.

Then, the information providing device provides a navigation route from the current location of the vehicle occupant to the location information (S440).

When the location information corresponding to at least one keyword includes a plurality of location coordinates, the information providing device may identify the location coordinates closest to the occupant's current location, and generate and provide a navigation route from the current location to the identified location coordinates.

In addition, the information providing device may provide various navigation routes from the current location to the location information based on map information. Further, the information providing device may provide congestion or accident information of the navigation route based on traffic information.

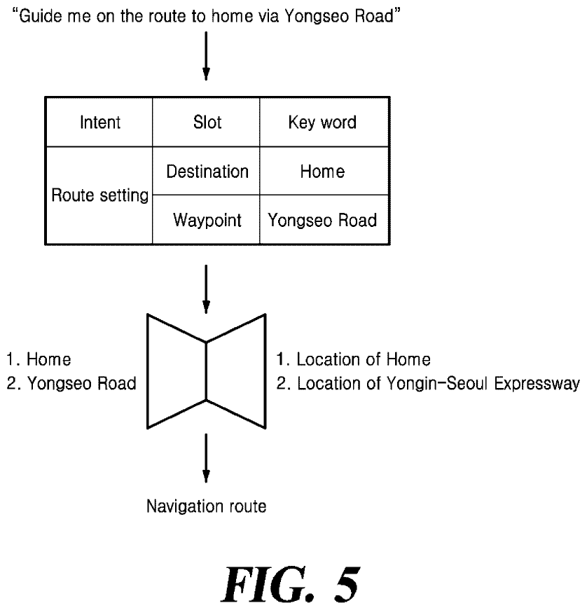

FIG. 5 is a diagram illustrating an example of the route providing method according to one embodiment of the present disclosure.

Referring to FIG. 5, the information providing device receives a speech utterance “Guide me on the route to home via Yongseo Road”. In this case, the word “Yongseo Road” is an abbreviation of the POI name “Yongin-Seoul Expressway”.

The information providing device classifies the utterance intent of the speech utterance. In this case, the utterance intent is classified as route setting.

The information providing device extracts keywords corresponding to the slot of the utterance intent. The slot of route setting intent includes at least one of a destination or a waypoint. The information providing device extracts “home” as a keyword corresponding to the destination, and extracts “Yongseo Road” as a keyword corresponding to the waypoint.

The information providing device searches for “home” as the POI name and location information corresponding to “home” from the POI DB. When the POI DB stores the POI name of “home” and location information thereof, the information providing device can obtain the location information of “home”.

In addition, the information providing device may search for location information of the keyword “Yongseo Road” by referring to the POI DB. The POI DB may store “Yongin-Seoul Expressway” and may not store “Yongseo Road”.

In this case, the information providing device can obtain location information of the “Yongin-Seoul Expressway” as location information of the “Yongseo Road” using the first deep learning model. Since the keyword “Yongseo Road” and the POI name “Yongin-Seoul Expressway” are similar texts, the first deep learning model may output location information similar to the location of “Yongin-Seoul Expressway” in response to the input of the keyword “Yongseo Road”.

Then, the information providing device may obtain the current location of the vehicle occupant, generate a navigation route from the current location to the location of “home” via the location of the “Yongin-Seoul Expressway”, and provide the navigation route.

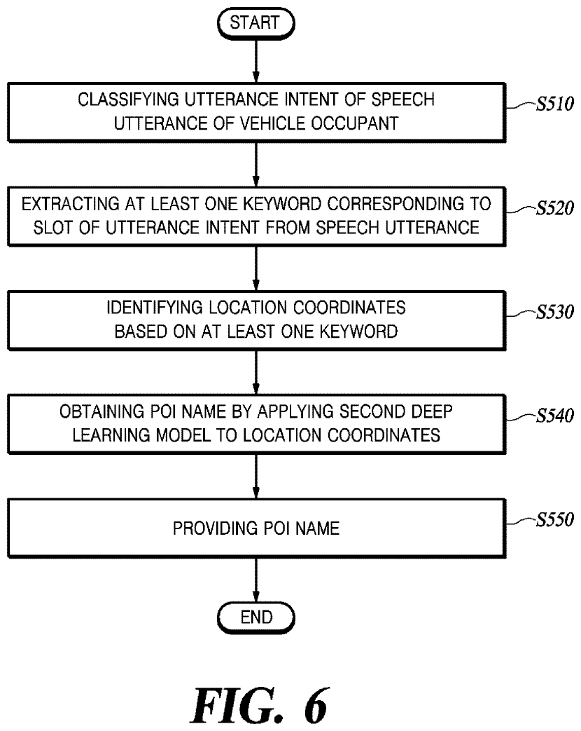

FIG. 6 is a flowchart of a method for providing a POI name according to one embodiment of the present disclosure.

Referring to FIG. 6, the information providing device classifies an utterance intent of a speech utterance of a vehicle occupant (S510).

According to one embodiment, the utterance intent may be classified as any one of POI guidance, route description, accident information guidance, or congested section check.

The information providing device extracts at least one keyword corresponding to the slot of utterance intent from the speech utterance (S520).

In this case, the extracted keyword may be text indicating a specific location or a specific spatial range.

The information providing device identifies location coordinates based on at least one keyword (S530).

When the utterance intent is POI guidance, the information providing device may identify first location coordinates around a target location according to at least one keyword. The first location coordinates represent location coordinates around the target location indicated by the keyword.

When the utterance intent is a route description, the information providing device may identify second location coordinates within a navigation route according to at least one keyword. The second location coordinates represent location coordinates constituting the navigation route.

When the utterance intent is accident information guidance, the information providing device may identify third location coordinates of an accident point within a spatial range according to at least one keyword based on accident information.

When the utterance intent is congested section check, the information providing device may identify fourth location coordinates for a congested section within a spatial range according to at least one keyword based on traffic information.

The information providing device obtains the POI name by applying the second deep learning model to the location coordinates (S540).

The information providing device may obtain at least one POI name from one location coordinate using the second deep learning model.

The information providing device provides the obtained POI name (S550).

The information providing device may provide the POI name to the occupant. Alternatively, the information providing device may generate a complete sentence from utterance intent, slot, keyword, and POI name using a generative model. The information providing device provides the generated sentence to the occupant.

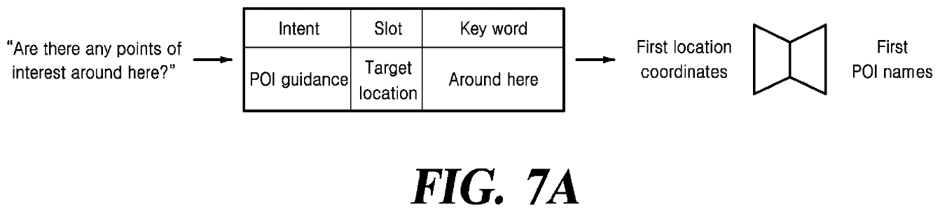

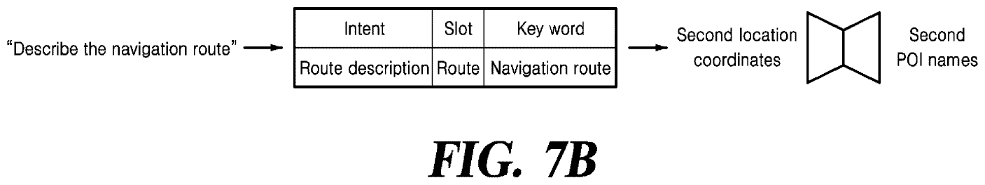

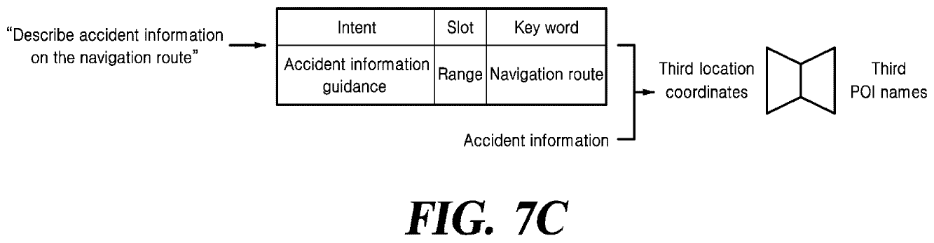

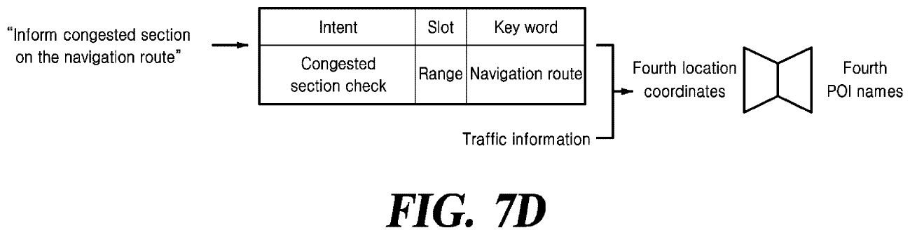

FIGS. 7A to 7D are diagrams illustrating examples of the POI name providing method according to one embodiment of the present disclosure.

Referring to FIG. 7A, the information providing device receives the occupant's utterance, “Are there any points of interest around here?”

The information providing device classifies the utterance intent for the received utterance. The utterance intent is classified as “POI guidance”.

The information providing device extracts a keyword corresponding to the slot of POI guidance intent. In this case, the slot of POI guidance intent may be predefined as “target location”. The information providing device extracts “around here” as the keyword corresponding to the slot.

The information providing device obtains location coordinates based on the keyword. Specifically, the target location according to the keyword “around here” means around the current location of the occupant. The information providing device obtains first location coordinates indicating locations around the current location of the occupant.

The information providing device obtains first POI names corresponding to the first location coordinates by applying the second deep learning model to the first location coordinates.

The information providing device provides the first POI names in response to the occupant's utterance. In particular, the information providing device may generate a sentence including the first POI names using the generative model and provide the sentence.

Referring to FIG. 7B, the information providing device receives the occupant's utterance, “Describe the navigation route.”

The information providing device classifies the utterance intent for the received utterance. The utterance intent is classified as a “route description”.

The information providing device extracts a keyword corresponding to the slot of the route description intent. In this case, the slot of the route description intent may be predefined as “route”. The information providing device extracts “navigation route” as the keyword corresponding to the slot.

The information providing device obtains location coordinates based on the keyword. Specifically, the keyword “navigation route” refers to the vehicle's currently set navigation route. The information providing device obtains second location coordinates constituting the current navigation route of the vehicle.

The information providing device obtains second POI names corresponding to the second location coordinates by applying the second deep learning model to the second location coordinates. The second POI names may include “Gangnam-daero,” “Yangjae-daero,” and “Gyeongbu Expressway”.

The information providing device provides second POI names in response to the occupant's utterance. In particular, the information providing device may generate a sentence including the second POI names using the generative model and provide the sentence.

Referring to FIG. 7C, the information providing device receives the occupant's utterance, “Describe accident information on the navigation route.”

The information providing device classifies the utterance intent for the received utterance. The utterance intent is classified as “accident information guidance”.

The information providing device extracts a keyword corresponding to the slot of the accident information guidance intent. In this case, the slot of the accident information guidance intent may be predefined as “range”. The information providing device extracts “navigation route” as the keyword corresponding to the slot.

The information providing device obtains location coordinates based on the keyword and accident information. Specifically, the keyword “navigation route” refers to the vehicle's currently set navigation route. The information providing device obtains third location coordinates for the accident point on the vehicle's current navigation route.

The information providing device obtains a third POI name corresponding to the third location coordinates.

The information providing device provides the third POI name in response to the occupant's utterance. In particular, the information providing device may generate a sentence including the third POI name using the generative model and provide the sentence.

Referring to FIG. 7D, the information providing device receives the occupant's utterance, “Inform congested section on the navigation route.”

The information providing device classifies the utterance intent for the received utterance. The utterance intent is classified as “congested section check”.

The information providing device extracts a keyword corresponding to the slot of the congested section check intent. In this case, the slot of the congested section check intent may be predefined as a “range”. The information providing device extracts “navigation route” as the keyword corresponding to the slot.

The information providing device obtains location coordinates based on the keyword and traffic information. Specifically, the keyword “navigation route” refers to the vehicle's currently set navigation route. The information providing device obtains fourth location coordinates for the congested section on the vehicle's current navigation route.

The information providing device obtains a fourth POI name corresponding to the fourth location coordinates by applying the second deep learning model to the fourth location coordinates.

The information providing device provides the fourth POI name in response to the occupant's utterance. In particular, the information providing device may generate a sentence including the fourth POI name using the generative model and provide the sentence.

As described above, according to one embodiment of the present disclosure, the location for a name or abbreviation not stored in the POI DB can be retrieved from the utterance of a vehicle occupant, and a navigation route can be provided based on the location.

According to another embodiment of the present disclosure, response information to various utterances of the vehicle occupant can be provided using the deep learning model capable of flexible conversion between text information and location information.

Various techniques described herein may be implemented in digital electronic circuitry, or in computer hardware, firmware, software, or combinations thereof. Implementations may be in the form of a computer program tangibly embodied in a computer program product, i.e., an information carrier, e.g., a machine-readable storage device (computer-readable medium) or a propagated signal, for processing by, or controlling, the operation of, a data processing device, e.g., a programmable processor, a computer, or a number of computers. A computer program, such as the above-mentioned computer program(s), may be written in any form of programming language, including compiled or interpreted languages and may be deployed in any form, including as a stand-alone program or as a module, component, subroutine, or other unit suitable for use in a computing environment. The computer program may be deployed to run on a single computer or multiple computers at one site or distributed across multiple sites and interconnected by a communications network.

In addition, components of the present disclosure may use an integrated circuit structure such as a memory, a processor, a logic circuit, a look-up table, and the like. These integrated circuit structures execute each of the functions described herein through the control of one or more microprocessors or other control devices. In addition, components of the present disclosure may be specifically implemented by a program or a portion of a code that includes one or more executable instructions for performing a specific logical function and is executed by one or more microprocessors or other control devices. In addition, components of the present disclosure may include or be implemented as a Central Processing Unit (CPU), a microprocessor, etc. that perform respective functions. In addition, components of the present disclosure may store instructions executed by one or more processors in one or more memories.

Processors suitable for processing computer programs include, by way of example, both general purpose and special purpose microprocessors, as well as one or more processors of any kind of digital computer. Generally, a processor will receive instructions and data from a read-only memory or a random access memory or both. The essential elements of a computer may include at least one processor that executes instructions and one or more memory devices that store instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include, by way of example, semiconductor memory devices, e.g., Magnetic Media such as hard disks, floppy disks, and magnetic tapes, Optical Media such as Compact Disk Read Only Memories (CD-ROMs) and Digital Video Disks (DVDs), Magneto-Optical Medial such as Floptical Disks, Rea Only Memories (ROMs), Random Access Memories (RAMs), flash memories, Erasable Programmable ROMs (EPROMs), Electrically Erasable Programmable ROMs (EEPROM), etc. The processor and the memory may be supplemented by, or incorporated in, special purpose logic circuitry.

The processor may execute an Operating System and software applications executed on the Operating System. Moreover, a processor device may access, store, manipulate, process, and generate data in response to software execution. For the sake of convenience, there is a case where a single processor device is used, but those skilled in the art will understand that the processor device can include multiple processing elements and/or multiple types of processing elements. For example, the processor device may include a plurality of processors or a single processor and a single controller. Other processing configurations, such as such as parallel processors, are also possible.

In addition, non-transitory computer-readable media may be any available media that can be accessed by a computer, and may include both computer storage media and transmission media.

This specification includes details of various specific implementations, but they should not be understood as limiting the scope of any invention or what is claimed, and should be understood as descriptions of features that may be unique to particular embodiments of a particular invention. In the context of individual embodiments, specific features described herein may also be implemented in combination with a single embodiment. On the contrary, various features described in the context of a single embodiment can also be implemented in multiple embodiments independently or in any appropriate sub-combination. Further, although the features may operate in a particular combination and may be initially described as so claimed, one or more features from the claimed combination may be in some cases excluded from the combination, and the claimed combination may be modified into a sub-combination or a variation of the sub-combination.

Likewise, although the operations are depicted in the drawings in a particular order, it should not be understood that such operations must be performed in that particular order or sequential order shown to achieve the desirable result or that all the depicted operations should be performed. In certain cases, multitasking and parallel processing may be advantageous. Moreover, the separation of various device components of the above-described embodiments should not be understood as requiring such separation in all embodiments, and it should be understood that the described program components and devices can generally be integrated together in a single software product or packaged into multiple software products.

The foregoing description is merely illustrative of the technical concept of the present embodiments. Various modifications and changes may be made by those of ordinary skill in the art without departing from the essential characteristics of each embodiment. Therefore, the present embodiments are not intended to limit but to describe the technical idea of the present embodiments. The scope of the technical concept of the embodiments is not limited by these embodiments. The scope of protection of the various embodiments should be construed by the following claims. All technical ideas that fall within the scope of equivalents thereof should be interpreted as being included in the scope of the present embodiments.

What is claimed is:

1. A device for providing information based on speech recognition, the device comprising:
at least one memory storing computer-executable instructions; and
at least one processor,
wherein the at least one processor is configured to execute the computer-executable instructions to:
classify an utterance intent of a speech utterance of an occupant of a vehicle,
extract at least one keyword corresponding to a slot of the utterance intent from the speech utterance,
obtain location information corresponding to the at least one keyword by applying a first deep learning model to the at least one keyword when the utterance intent is route setting, and
provide the occupant with a navigation route from a current location of the vehicle occupant to the location information.

2. The device of claim 1, when the utterance intent is any one of a point of interest (POI) guidance, a route description, an accident information guidance, or a congested section check, wherein the at least one processor is configured to:
identify location coordinates based on the at least one keyword,
obtain a POI name by applying a second deep learning model to the location coordinates, and
provide the POI name.

3. The device of claim 2, wherein the first deep learning model includes:
a text encoder trained to encode a training input keyword into a first vector representation; and
a location decoder trained to output a training output location corresponding to the training input keyword from the first vector representation.

4. The device of claim 3, wherein the second deep learning model includes:
a location encoder trained to encode a training input location into a second vector representation; and
a text decoder trained to output a training output keyword corresponding to the training input location from the second vector representation.

5. The device of claim 4, wherein the text encoder and the location encoder have trained to reduce a difference between the first vector representation and the second vector representation when the training input keyword corresponds to the training input location.

6. The device of claim 2, wherein when the utterance intent is the POI guidance, the at least one processor is configured to:
obtain first location coordinates around a target location according to the at least one keyword,
obtain first POI names by applying the second deep learning model to the first location coordinates, and
provide the first POI names.

7. The device of claim 2, wherein when the utterance intent is the route description, the at least one processor is configured to:
obtain second location coordinates within the navigation route according to the at least one keyword,
obtain second POI names by applying the second deep learning model to the second location coordinates, and
provide the second POI names.

8. The device of claim 2, wherein when the utterance intent is the accident information guidance, the at least one processor is configured to:
identify third location coordinates for an accident point within a spatial range according to the at least one keyword based on accident information,
obtain a third POI name by applying the second deep learning model to the third location coordinates, and
provide the third POI name.

9. The device of claim 2, wherein when the utterance intent is the congested section check, the at least one processor is configured to:
identify fourth location coordinates for a congested section within a spatial range according to the at least one keyword based on traffic information,
obtain a fourth POI name by applying the second deep learning model to the fourth location coordinates, and
provide the fourth POI name.

10. A vehicle comprising the device of claim 1.

11. A computer implemented method for providing information based on speech information, the method comprising:
classifying an utterance intent of a speech utterance of an occupant of a vehicle;
extracting at least one keyword corresponding to a slot of the utterance intent from the speech utterance;
obtaining location information corresponding to the at least one keyword by applying a first deep learning model to the at least one keyword when the utterance intent is route setting; and
providing the occupant with a navigation route from a current location of the vehicle occupant to the location information.

12. The method of claim 11, further comprising: when the utterance intent is any one of POI guidance, route description, accident information guidance, or congested section check,
identifying location coordinates based on the at least one keyword;
obtaining a POI name by applying a second deep learning model to the location coordinates; and
providing the POI name.

13. The method of claim 12, wherein the first deep learning model includes:
a text encoder trained to encode a training input keyword into a first vector representation; and
a location decoder trained to output a training output location corresponding to the training input keyword from the first vector representation.

14. The method of claim 13, wherein the second deep learning model includes:
a location encoder trained to encode a training input location into a second vector representation; and
a text decoder trained to output a training output keyword corresponding to the training input location from the second vector representation.

15. The method of claim 14, wherein the text encoder and the location encoder have trained to reduce a difference between the first vector representation and the second vector representation when the training input keyword corresponds to the training input location.

16. The method of claim 12, wherein when the utterance intent is the POI guidance, the identifying of the location coordinates includes:
obtaining first location coordinates around a target location according to the at least one keyword; and
obtaining first POI names by applying the second deep learning model to the first location coordinates.

17. The method of claim 12, wherein when the utterance intent is the route description, the identifying of the location coordinates includes:
obtaining second location coordinates within the navigation route according to the at least one keyword; and
obtaining second POI names by applying the second deep learning model to the second location coordinates.

18. The method of claim 12, wherein when the utterance intent is the accident information guidance, the identifying of the location coordinates includes:
identifying third location coordinates for an accident point within a spatial range according to the at least one keyword based on accident information; and
obtaining a third POI name by applying the second deep learning model to the third location coordinates.

19. The method of claim 12, wherein when the utterance intent is the congested section check, the identifying of the location coordinates includes:
identifying fourth location coordinates for a congested section within a spatial range according to the at least one keyword based on traffic information; and
obtaining a fourth POI name by applying the second deep learning model to the fourth location coordinates.
